(19) United States
(12) Patent Application Publication
(10) Pub. No.: US 2009/0241712 A1
(43) Pub. Date: Oct. 1, 2009

(54) WORM GEAR MECHANISM

(75) Inventors: Yasuaki Suzuki, Kariya-shi (JP); Yuki Okabe, Kakamigahara-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 12/388,023

(22) Filed: Feb. 18, 2009

(30) Foreign Application Priority Data
Mar. 26, 2008 (JP) 2008-080230

(51) Int. Cl. F16H 1/16

(52) U.S. Cl. 74/425

(57) ABSTRACT

A worm gear mechanism includes a worm wheel having a central axis; and a worm shaft made of resin having a rotational axis and a plurality of geared portions which engages with the worm wheel, the worm shaft allowing the worm wheel to rotate about the central axis of the worm wheel when rotating about the rotational axis of the worm shaft, tooth root portions of the geared portions being configured to have a profile which varies gradually along an axial direction of the worm shaft relative to a datum line being perpendicular to the axial direction of the worm shaft and passing through the central axis of the worm wheel.

### CROSS REFERENCE TO RELATED APPLICATIONS

This application is based on and claims priority under 35 U.S.C. § 119 to Japanese Patent Application 2008-080230, filed on Mar. 26, 2008, the entire content of which is incorporated herein by reference.

### FIELD OF THE INVENTION

The present invention relates to a worm gear mechanism including a resin-molded worm shaft.

### BACKGROUND

A conventional worm gear mechanism disclosed in JP7309244A (hereinafter referred to as Patent Document 1) includes a worm shaft composed of gear teeth having tooth widths gradually increasing along an axial direction of the worm shaft.

Furthermore, a gear wheel disclosed in JP2007247894A (hereinafter referred to as Patent Document 2) includes a plurality of gear teeth engaging with teeth of a counterpart gear wheel, thereby transmitting a rotational movement of the gear wheel to the counterpart gear wheel. Each of the gear teeth of the gear wheel is formed by thickening a circumferential tooth width on one axial end face and thinning a circumferential tooth width on the other axial end face against a tooth profile of a standard gear wheel and by arranging smoothly slanted tooth-surfaces extending along both face widths of each of the gear teeth, between the axial end face and the other axial end face in such a way that a transverse cross-sectional shape of each of the gear teeth parallel to a rotating shaft of the gear wheel is formed in an approximately trapezoidal shape.

Moreover, a worm gear mechanism disclosed in JP2003080564A includes a worm wheel and an injection-molded plastic worm shaft. The injection-molded plastic worm shaft includes a half-split hand-drum-shaped worm shaft portion split perpendicular to a rotational axis of the injection-molded plastic worm shaft and a cylindrical worm shaft portion formed integrally with a small diameter periphery of the half-split hand-drum-shaped worm shaft portion.

Moreover, the worm gear mechanism disclosed in Patent Document 1 has the gear teeth having the tooth tip widths formed so as to gradually increase along the axial direction of the worm shaft. Accordingly, even when it is required to increase the tooth widths of the gear teeth in order to prevent interference between the worm wheel and the worm shaft, thickness that can be added is slight, therefore hardly increasing the strength of the worm shaft.

Moreover, the gear wheel disclosed in Patent Document 2 has the thick circumferential tooth width on the axial end face and the thin circumferential tooth width on the other axial end face. Accordingly, the tooth thickness as a whole is not increased. Consequently, even when such configuration of the gear teeth is applied to a worm shaft, the strength of the worm shaft is not secured.

In addition, the half-split hand-drum-shaped worm shaft portion disclosed in Patent Document 3 and the shaft-bearing portion require high accuracy while being processed. Further, it is difficult to remove the molded half-split hand-drum-shaped worm shaft portion from the mold, resulting in an increase of manufacturing costs.

A need thus exists for a worm gear mechanism, which is not susceptible to the drawback mentioned above.

### SUMMARY OF THE INVENTION

According to an aspect of the present invention, a worm gear mechanism a worm wheel having a central axis; and

a worm shaft made of resin having a rotational axis and a plurality of geared portions which engage with the worm wheel, the worm shaft allowing the worm wheel to rotate about the central axis of the worm wheel when rotating about the rotational axis of the worm shaft, tooth root portions of the geared portions being configured to have a profile which varies gradually along an axial direction of the worm shaft relative to a datum line being perpendicular to the axial direction of the worm shaft and passing through the central axis of the worm wheel.

### BRIEF DESCRIPTION OF THE DRAWINGS

The foregoing and additional features and characteristics of the present invention will become more apparent from the following detailed description considered with reference to the accompanying figures, wherein:

FIG. 1 is a cross-sectional view illustrating a worm gear mechanism including a worm wheel and a resin-molded hollow cylindrical worm shaft according to a first embodiment of the present invention; and

FIG. 2 is a cross-sectional view illustrating a worm gear mechanism including a worm wheel and a resin-molded hollow cylindrical worm shaft according to a second embodiment of the present invention.

### DETAILED DESCRIPTION

A first embodiment of the present invention of a worm gear mechanism will be explained with reference to the illustrations of the figures as follows. In addition, the first embodiment will be described by applying a worm shaft having a hollow cylindrical shape. However, the worm shaft is not limited to the hollow cylindrical-shaped worm shaft. For example, a cylindrical column-shaped worm shaft may be applied.

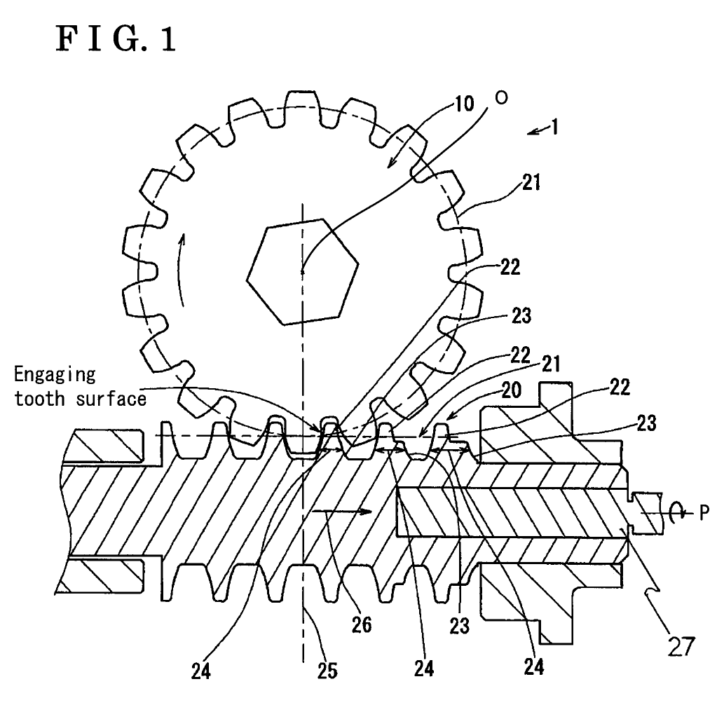

FIG. 1 is a cross-sectional view illustrating a worm gear mechanism 1 according to the first embodiment, including a worm wheel 10 and a resin-molded hollow cylindrical worm 20 serving as a worm shaft. The worm wheel 10 has a central axis “O” and the resin-molded hollow cylindrical worm 20 has a rotational axis “P” and teeth (i.e. geared portions) having tooth root portions 21. The hollow cylindrical worm 20 rotates about the rotational axis “P” while engaging with the worm wheel 10, thereby allowing the worm wheel 10 to rotate clockwise about the central axis “O” in FIG. 1. The worm wheel 10 rotates along with the rotation of the hollow cylindrical worm 20 while receiving a rotational force of the hollow cylindrical worm 20. The hollow cylindrical worm 20 is injection-molded with a molten resin such as polyacetal resin, polyamide resin, polyphenylene sulfide resin, and polybutylene terephthalate resin. Furthermore, the tooth root portions 21 of the hollow cylindrical worm 20 forms profiles gradually varying in an area of the hollow cylindrical worm 20, which axially ranges from a datum line 25 being perpendicular to an axial direction 26 (shown by an arrow facing to the right in FIG. 1) of the hollow cylindrical worm 20 and passing through the central axis “O” of the worm wheel 10. The gradual variations of the profiles of the tooth root portions 21 of the hollow cylindrical worm 20 are equal to gradual variations of tooth widths 24 of the tooth root portions 21. The gradual variations of the tooth widths 24 are obtained by forming axially protruding portions in the respective tooth root portions 21. Accordingly, the tooth widths 24 of the tooth root portions 21 are gradually increased in the area of the hollow cylindrical worm 20 axially ranging from the datum line 25. The protruding portion of each of the tooth root portions 21 forms a first tooth surface 22 and a second tooth surface 23. Further, the hollow cylindrical worm 20 has an engaging tooth surface arranged to face the datum line 25 and engaging with the worm wheel 10 and. The second tooth surface 23 of the hollow cylindrical worm 20 is formed in the opposite direction of the engaging tooth surface as shown in FIG. 1. A metallic core 27 is arranged within the hollow cylindrical worm 20, thereby increasing the strength of the hollow cylindrical worm 20.

When the hollow cylindrical worm 20 rotates, teeth of the worm wheel 10 and the teeth of the hollow cylindrical worm 20 make contact with one another. Accordingly, a rotating force of the hollow cylindrical worm 20 is transmitted to the worm wheel 10. At this time, a pressing force is applied to a contact point at which each of the teeth of the hollow cylindrical worm 20 makes contact with each of the teeth of the worm wheel 10. That is, the tooth widths 24 of the tooth root portions 21 are formed so as to gradually vary along the axial direction 26 of the hollow cylindrical worm 20. In addition, the projecting portion of each of the tooth root portions 21 is formed axially in an area of the hollow cylindrical worm 20, at which a maximum stress occurs when the worm wheel 10 is rotated along with the rotation of the hollow cylindrical worm 20, so that the tooth widths 24 vary along the axial direction 26 of the hollow cylindrical worm 20. Consequently, stress occurring at the tooth root portions 21 of the hollow cylindrical worm 20 is decreased.

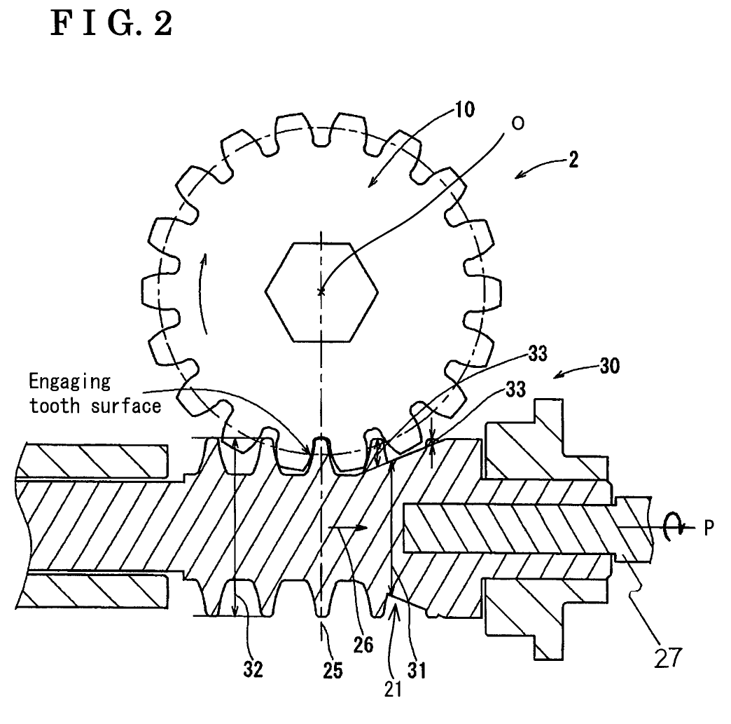

Next, a worm gear mechanism 2 according to a second embodiment will be described below with reference to FIG. 2. FIG. 2 is a cross-sectional view illustrating the worm gear mechanism 2 of the second embodiment. Similar functions and portions to those of the worm gear mechanism 1 of the first embodiment will be explained by using the same numbers. The worm gear mechanism 2 is different from the worm gear mechanism 1 in that the tooth root portions 21 of a hollow cylindrical worm 30 have profiles gradually varying in an area of the hollow cylindrical worm 30, which ranges from the datum line 25 in the axial direction 26 (shown by the arrow facing to the right in FIG. 2) of the hollow cylindrical worm 30. The gradual variations of the profiles of the tooth root portions 21 of the hollow cylindrical worm 30 are equal to gradual variations of tooth root diameters 31 of the hollow cylindrical worm 30. The gradual variations of the tooth root diameters 31 are obtained by forming a projecting portion axially extending and projecting radially outwardly from the hollow cylindrical worm 30. Accordingly, the tooth root diameters 31 are formed so as to gradually increase in the area of the hollow cylindrical worm 30 axially ranging from the datum line 25. In addition, the radially outwardly projecting portion is formed axially in an area of the hollow cylindrical worm 30, at which a maximum stress occurs when the worm wheel 10 is rotated along with the rotation of the hollow cylindrical worm 30.

The hollow cylindrical worm 30 is injection-molded with a molten resin such as polyacetal resin, polyamide resin, polyphenylene sulfide resin, and polybutylene terephthalate resin. The tooth root diameters 31 of the hollow cylindrical worm 30 are located axially and in the opposite direction of the engaging tooth surface engaging with the worm wheel 10 so as to gradually increase in the area of the hollow cylindrical worm 30 ranging from the datum line 25 in the axial direction 26 of the hollow cylindrical worm 30.

When the hollow cylindrical worm 30 rotates, the teeth of the worm wheel 10 and teeth of the hollow cylindrical worm 30 make contact with one another. Accordingly, a rotational force of the hollow cylindrical worm 30 is transmitted to the worm wheel 10. At this time, a pressing force is applied to a contact point at which each of the teeth of the hollow cylindrical worm 30 makes contact with each of the teeth of the worm wheel 10. The tooth root diameters 31 of the hollowing cylindrical worm 30 are gradually increased in the area of the hollow cylindrical worm 30 ranging from the datum line 25 in the axial direction 26 of the hollow cylindrical worm 30. When a tooth tip diameter 32 of the hollow cylindrical worm 30 is uniform, whole depths 33 of the teeth of the hollow cylindrical worm 30 are gradually shortened in the area of the hollow cylindrical worm 30 ranging from the datum line 25 in the axial direction 26 of the hollow cylindrical worm 30.

(Analytical Result)

TABLE 1

| | Model of worm | Hollow cylindrical | Hollow cylindrical |
|---|---|---|---|
| | shaft forming a | worm 20 (first | worm 30 (second |
| | reference shape | embodiment) | embodiment) |
| Maximum | 319 MPa | 284 MPa | 271 MPa |
| tensile stress | | | |
| Maximum | 94 MPa | 81 MPa | 114 MPa |
| compressive | | | |
| stress | | | |

Maximum stress occurring at the tooth root portions 21 of the hollow cylindrical worm 20 of the first embodiment and at the tooth root portions 21 of the hollow cylindrical worm 30 of the second embodiment is numerically analyzed by using finite element methods. The obtained maximum stress is compared to a maximum stress occurring at a model of a worm shaft including tooth root portions each forming a uniform tooth profile. The above Table 1 shows the comparison results. The maximum stress occurring at the hollow cylindrical worm 20 and the hollow cylindrical worm 30 is a main cause of fractures of the tooth root portions 21. Compared to the maximum stress generated at the model of the worm shaft, the maximum stress generated at the hollow cylindrical worm 20 is reduced by 11 percent while the maximum stress generated at the hollow cylindrical worm 30 is reduced by 15 percent. Furthermore, maximum compressive stress generated at the tooth root portions 21 of the hollow cylindrical worm 20 is reduced by 14 percent, compared to maximum compressive stress generated at the model of the worm shaft.

In the first embodiment, each of the tooth root portions 21 forms the first tooth surface 22 and the second tooth surface 23. Further, the tooth widths 24 of the tooth root portions 21 are gradually increased in the area of the hollow cylindrical worm 20 ranging from the datum line 25 in the axial direction 26 of the hollow cylindrical worm 20. Accordingly, the tooth widths 24 of the tooth root portions 21 are increased in the axial direction 26 while interference between the hollow cylindrical worm 20 and the worm wheel 10 is prevented. Consequently, the strength of the tooth root portions 21 is increased.

In addition, after a mold used for molding a worm shaft is processed by electric discharge machining with a master gear, the mold is reprocessed with a different master gear having a different hollow cylindrical shape and a long pitch. Accordingly, the mold is processed so that tooth root portions of a molded worm shaft can be thickened as far as gearing between the molded worm shaft and a worm wheel is not hindered. Thus, the hollow cylindrical worm 20 having the tooth width 24 of the tooth root portion 21 larger than a tooth width of a conventional worm is obtained while manufacturing costs are minimized.

In addition, according to the second embodiment, the tooth root diameters 31 of the hollow cylindrical worm 30 are gradually increased in the area of the hollow cylindrical worm 30 ranging from the datum line 25 in the axial direction 26 of the hollow cylindrical worm 30. Accordingly, the axial rigidity of the hollow cylindrical worm 30 is increased and a shallow or insufficient engagement between the worm wheel 10 and the hollow cylindrical worm 30 is prevented because the hollow cylindrical worm 30 may not be deflected in a downward direction in FIG. 2. Consequently, the strength of the hollow cylindrical worm 30 is increased. Further, a bending moment applied to the tooth root portions 21 of the hollow cylindrical worm 30 is reduced because the whole depths 33 of the hollow cylindrical worm 30 are gradually shortened in the area of the hollow cylindrical worm 30 ranging from the datum line 25 in the axial direction 26 of the hollow cylindrical worm 30, thereby decreasing stress occurring at the tooth root portions 21 of the hollow cylindrical worm 30.

Moreover, after the mold used for molding the worm shaft is processed by electric discharge machining with the master gear or by electroforming, the mold is processed by chamfering gear teeth portions of the molded worm shaft, so that gradients are added to the gear teeth portions. Consequently, the hollow cylindrical worm 30 having the tooth root diameters 31 gradually increased in the area of the hollow cylindrical worm 30 axially ranging from the datum line 25 is obtained while manufacturing costs are minimized.

The hollow cylindrical worms 20 and 30 according to the first and second embodiments are formed by injection molding. However, a worm shaft including a simple metallic core therewithin as a shaft portion may be applied. In this case, a hollow cylindrical worm shaft having high strength is obtained at low cost compared to a case where a worm shaft is formed by processing a metal bar.

As described above, the stress occurring at the tooth root portions 21 is reduced by gradually and axially varying the profiles of the tooth root portions 21 of the hollow cylindrical worm 20. In addition, the hollow cylindrical worm 20 is configured so that interference between the worm wheel 10 and the hollow cylindrical worm 20 is prevented by gradually and axially varying the profiles of the tooth root portions 21 in an area of the hollow cylindrical worm 20, which is defined between a reference pitch diameter and a tooth root diameter. Consequently, the hollow cylindrical worm 20 and the shaft-bearing portion do not require high accuracy while being processed. Moreover, the molded hollow cylindrical worm 20 is easily removed from a mold used for molding the hollow cylindrical worm 20, thereby minimizing the manufacturing costs.

According to the aforementioned embodiments, the gradual variations of the profiles of the tooth root portions 21 of the hollow cylindrical worm 20 are equal to the gradual variations of the tooth widths 24 of the tooth root portions 21 of the hollow cylindrical worm 20.

Further, according to the aforementioned embodiments, the gradual variations of the tooth widths 24 of the tooth root portions 21 of the hollow cylindrical worm 20 are obtained by forming the projecting portions projecting axially in the tooth root portions 21.

Furthermore, according to the aforementioned embodiments, the gradual variations of the profiles of the tooth root portions 21 of the hollow cylindrical worm 20 are obtained in the area of the hollow cylindrical worm 20, at which a maximum stress occurs when the worm wheel 10 is rotated along with the rotation of the hollow cylindrical worm 20.

Moreover, each of the tooth root portions 21 forms the first tooth surface 22 and the second tooth surface 23. The tooth widths 24 of the tooth root portions 21 are gradually and axially increased in the area of the hollow cylindrical worm 20 axially ranging from the datum line 25. Further, interference between the worm wheel 10 and the hollow cylindrical worm 20 is prevented. Consequently, the strength of the tooth root portions 21 is increased. In addition, after the mold used for molding the hollow cylindrical worm 20 is processed by electric discharge machining with a master gear, the mold is reprocessed with a different master gear having a different hollow cylindrical shape and a long pitch. Accordingly, the mold is processed so that tooth root portions of the molded hollow cylindrical worm 20 can be thickened as far as gearing between the hollow cylindrical worm 20 and the worm wheel 10 is not hindered. Thus, the hollow cylindrical worm 20 having the tooth width 24 of the tooth root portion 21 larger than the tooth width of the conventional worm is obtained while the manufacturing costs are minimized.

According to the aforementioned embodiments, the resin used for molding the hollow cylindrical worm 20, 30 is selected from at least one of polyacetal resin, polyamide resin, polyphenylene sulfide resin, and polybutylene terephthalate resin.

Further, according to the aforementioned embodiments, the gradual variations of the profiles of the tooth root portions 21 of the hollow cylindrical worm 30 are equal to the gradual variations of the tooth root diameters 31 of the tooth root portions 21 of the hollow cylindrical worm 30.

Furthermore, according to the aforementioned embodiments, the gradual variations of the tooth root diameters 31 of the tooth root portions 21 of the hollow cylindrical worm 30 are obtained by forming the projecting portion axially extending and protruding radially outwardly from the hollow cylindrical worm 30.

In addition, according to the aforementioned embodiments, the gradual variations of the tooth root diameters 31 of the tooth root portions 21 of the hollow cylindrical worm 30 are obtained in the area of the hollow cylindrical worm 30, at which a maximum stress occurs when the worm wheel 10 is rotated along with the rotation of the hollow cylindrical worm 30.

Accordingly, the tooth root diameters 31 of the hollowing cylindrical worm 30 are gradually increased in the area of the hollow cylindrical worm 30 ranging from the datum line 25 in the axial direction 26 of the hollow cylindrical worm 30. Accordingly, the axial rigidity of the hollow cylindrical worm 30 is increased and a shallow or insufficient engagement between the worm wheel 10 and the hollow cylindrical worm 30 is prevented because the hollow cylindrical worm 30 may not be deflected in the downward direction in FIG. 2. Consequently, the strength of the hollow cylindrical worm 30 is increased. Further, a bending moment applied to the tooth root portions 21 of the hollow cylindrical worm 30 is reduced because the whole depths 33 of the hollow cylindrical worm 30 are gradually shortened in the area of the hollow cylindrical worm 30 ranging from the datum line 25 in the axial direction 26 of the hollow cylindrical worm 30, thereby decreasing stress occurring at the tooth root portions 21 of the hollow cylindrical worm 30. Moreover, a mold used for molding the hollow cylindrical worm 30 is processed by electric discharge machining with a master gear or by electroforming, the mold is processed by chamfering gear teeth portions of the molded hollow cylindrical worm 30, so that gradients are added to the gear teeth portions. Consequently, the hollow cylindrical worm 30 having the tooth root diameters 31 gradually and axially increased in the area of the hollow cylindrical worm 30 axially ranging from the datum line 25 is obtained while the manufacturing costs are minimized.

Further, according to the aforementioned embodiments, the projecting portion of the tooth root portion 21 is formed in the area of the hollow cylindrical worm 20, 30, at which a maximum stress occurs when the worm wheel 10 is rotated along with the rotation of the hollow cylindrical worm 20, 30.

Furthermore, according to the aforementioned embodiments, the area of the hollow cylindrical worm 20, 30 receiving the maximum stress is located axially and in the opposite direction of the engaging tooth surface that is arranged to face the datum line 25 being perpendicular to the axial direction 26 of the hollow cylindrical worm 20, 30 and passing through the central axis of the worm wheel 10.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A worm gear mechanism, comprising:
a worm wheel having a central axis; and
a worm shaft made of resin having a rotational axis and a plurality of geared portions which engage with the worm wheel, the worm shaft allowing the worm wheel to rotate about the central axis of the worm wheel when rotating about the rotational axis of the worm shaft, tooth root portions of the geared portions being configured to have a profile which varies gradually along an axial direction of the worm shaft relative to a datum line being perpendicular to the axial direction of the worm shaft and passing through the central axis of the worm wheel.

2. The worm gear mechanism according to claim 1, wherein the gradual variations of the profiles of the geared portions of the worm shaft are in the form of gradual variations of tooth widths of the geared portions of the worm shaft.

3. The worm gear mechanism according to claim 2, wherein the gradual variations of the tooth widths of the geared portions of the worm shaft are obtained by forming projecting portions projecting axially in the tooth root portions.

4. The worm gear mechanism according to claim 2, wherein the gradual variations of the profiles of the tooth root portions of the worm shaft are obtained in an area of the worm shaft, at which a maximum stress occurs when the worm wheel is rotated along with the rotation of the worm shaft.

5. The worm gear mechanism according to claim 1, wherein the resin is selected from the group consisting of polyacetal resin, polyamide resin, polyphenylene sulfide resin, and polybutylene terephthalate resin.

6. The worm gear mechanism according to claim 1, wherein the gradual variations of the profiles of the tooth root portions of the worm shaft are in the form of gradual variations of tooth root diameters of the geared portions of the worm shaft.

7. The worm gear mechanism according to claim 6, wherein the gradual variations of the tooth root diameters of the tooth root portions of the worm shaft are obtained by forming a projecting portion axially extending and protruding radially outwardly from the worm shaft.

8. The worm gear mechanism according to claim 6, wherein the gradual variations of the profiles of the tooth root portions of the worm shaft are obtained in an area of the worm shaft, at which a maximum stress occurs when the worm wheel is rotated along with the rotation of the worm shaft.

9. A worm gear mechanism, comprising:
a worm wheel having a central axis; and
a worm shaft made of resin, having a rotational axis and a plurality of teeth portions, and allowing the worm wheel to rotate about the central axis of the worm wheel when rotating about the rotational axis of the worm shaft, each of the teeth portions having an engaging tooth surface and a tooth root portion, the engaging tooth surface engaging with the worm wheel, the tooth root portion including a projecting portion projecting in the axial direction of the worm shaft and in the opposite direction of the engaging tooth surface.

10. A worm gear mechanism according to claim 9, wherein the projecting portion of the tooth root portion is formed in an area of the worm shaft, at which a maximum stress occurs when the worm wheel is rotated along with the rotation of the worm shaft.

11. A worm gear mechanism according to claim 10, wherein the area of the worm shaft receiving the maximum stress is located axially and in the opposite direction of the engaging tooth surface that is arranged to face a datum line being perpendicular to an axial direction of the worm shaft and passing through the central axis of the worm wheel.
